(19) United States
(12) Patent Application Publication
(10) Pub. No.: US 2024/0347801 A1
(43) Pub. Date: Oct. 17, 2024

(54) PROCESS FOR RECYCLING LITHIUM ION BATTERY MATERIALS

(71) Applicant: BASF SE, Ludwigshafen am Rhein (DE)

(72) Inventors: Wolfgang Rohde, Ludwigshafen (DE); Dieter G Von Deak, Beachwood, OH (US); Birgit Gerke, Ludwigshafen (DE)

(73) Assignee: BASF SE, Ludwigshafen am Rhein (DE)

(21) Appl. No.: 18/579,698

(22) PCT Filed: Jul. 22, 2022
(86) PCT No.: PCT/EP2022/070700

§ 371 Date: Jan. 16, 2024

(30) Foreign Application Priority Data
Jul. 23, 2021 (EP) 21187550.5

(51) Int. Cl. H01M 10/54; C22B 3/22; C22B 7/00; C22B 26/12; C25B 1/26

(52) U.S. Cl. CPC H01M 10/54; C22B 3/22; C22B 7/005; C22B 7/006; C22B 26/12; C25B 1/26

(57) ABSTRACT

Disclosed herein are processes for removing lithium from a battery material comprising contacting the battery material with an aqueous medium comprising calcium hypochlorite salts to form a mixture, and separating in the mixture solids from liquids to obtain an aqueous solution comprising lithium ions. Also disclosed are processes for recycling lithium ion battery materials.

The project leading to this application has received funding from the European Union's Horizon 2020 research and innovation programme under Specific Grant Agreement No EIT/RAW MATERIALS/SGA2020/1, Project Agreement No. 19211.

Disclosed herein are processes for removing lithium from a battery material comprising contacting the battery material with an aqueous medium comprising at least one salt chosen from calcium hypochlorite, lithium hypochlorite, and combinations thereof to form a mixture, and separating in the mixture solids from liquids to obtain an aqueous solution comprising lithium ions. Also disclosed are processes for recycling lithium ion battery materials.

Lithium ion battery materials are a valuable source of lithium. The removal of lithium from a battery material is an important step for recycling lithium ion battery materials. Lithium ion battery materials are complex mixtures of various elements and compounds, and it may be desirable to separate various non-lithium impurities. Removal of lithium from a battery material using, e.g., sodium hypochlorite may result in a self-quenching pH increase and may provide unsatisfactory lithium recovery and/or unsatisfactory lithium purity.

Accordingly, there is a need for processes for removing lithium from a battery material and processes for recycling lithium ion battery materials. For example, there is a need for economic processes with high lithium recovery and high lithium purity.

Disclosed herein are processes for removing lithium from a battery material comprising contacting the battery material with an aqueous medium comprising at least one salt chosen from calcium hypochlorite, lithium hypochlorite, and combinations thereof to form a mixture, and separating in the mixture solids from liquids to obtain an aqueous solution comprising lithium ions.

In some embodiments, the battery material comprises at least one chosen from lithiated nickel cobalt manganese oxide, lithiated nickel cobalt aluminum oxide, lithium metal phosphate, lithium ion battery scrap, and black mass derived from a lithium ion battery.

In some embodiments, the battery material comprises lithium metal phosphate of formula LiₓMPO₄ wherein x is an integer greater than or equal to one, and M is chosen from metals, transition metals, rare earth metals, and combinations thereof.

In some embodiments, the battery material comprises lithiated nickel cobalt manganese oxide of formula Li₁₊ₓ(NiₐCo_{b}Mn_{c}M¹_{d})₁₋ₓO₂, wherein M¹ is chosen from Mg, Ca, Ba, Al, Ti, Zr, Zn, Mo, V and Fe, zero≤x≤0.2, 0.1≤a≤0.95, zero≤b≤0.9 (such as 0.05<b≤0.5), zero≤c≤0.6, zero≤d≤0.1, and a+b+c+d=1.

In some embodiments, the battery material comprises lithiated nickel-cobalt aluminum oxides of formula Li[NiₕCOᵢAlⱼ]O₂₊ᵣ, wherein h ranges from 0.8 to 0.90, i ranges from 0.1 to 0.3, j ranges from 0.01 to 0.10, and r ranges from zero to 0.4.

In some embodiments, the battery material comprises nickel, cobalt, manganese, copper, aluminum, iron, phosphorus, or combinations thereof.

In some embodiments, wherein the battery material has a weight ratio ranging from 0.01 to 10 of lithium to a total weight of nickel, cobalt, manganese, copper, aluminum, iron, and phosphorus. In some embodiments, wherein the battery material has a weight ratio ranging from 0.01 to 5 of lithium to a total weight of nickel, cobalt, manganese, copper, aluminum, iron, and phosphorus. In some embodiments, wherein the battery material has a weight ratio ranging from 0.01 to 2 of lithium to a total weight of nickel, cobalt, manganese, copper, aluminum, iron, and phosphorus. In some embodiments, wherein the battery material has a weight ratio ranging from 0.01 to 1 of lithium to a total weight of nickel, cobalt, manganese, copper, aluminum, iron, and phosphorus.

In some embodiments, at the contacting step, a weight ratio of the at least one salt chosen from calcium hypochlorite, lithium hypochlorite, and combinations thereof to a total weight of the battery material ranges from 0.1 to 100.

In some embodiments, the contacting step is at a temperature ranging from 20° C. to 100° C. for a duration ranging from 10 minutes to 10 hours.

In some embodiments, the separating step comprises at least one process chosen from filtration, decantation, centrifugation, sedimentation and combinations thereof to separate the solids from the liquids.

In some embodiments, the process further comprises purifying the aqueous solution comprising lithium ions by at least one process chosen from adsorption, ion exchange, precipitation, crystallization, nanofiltration, concentration by water removal, drowning-out crystallization, re-dissolution of a lithium salt in an organic solvent, and combinations thereof.

In some embodiments, the process further comprises subjecting the aqueous solution comprising lithium ions to a chlor-alkali-electrolysis process to obtain lithium hydroxide and chlorine gas.

In some embodiments, the chlorine gas is used to produce chlorinated lime and/or lithium hypochlorite.

In some embodiments, the chlorinated lime and/or lithium hypochlorite produced from the chlorine gas obtained from the chlor-alkali-electrolysis is used for removing lithium from a battery material.

In some embodiments, calcium hydroxide is recovered from the solids.

In some embodiments, the calcium hydroxide is used to produce chlorinated lime.

Also disclosed herein are processes for recycling lithium ion battery materials comprising mechanically comminuting at least one chosen from a lithium ion battery, lithium ion battery waste, lithium ion battery production scrap, lithium ion cell production scrap, lithium ion cathode active material, and combinations thereof to obtain a black mass, contacting the black mass with an aqueous medium comprising at least one salt chosen from calcium hypochlorite, lithium hypochlorite, and combinations thereof, and separating solids from liquids to obtain an aqueous solution comprising lithium ions.

### BRIEF DESCRIPTION OF THE DRAWINGS

FIG. 1 depicts an exemplary process for removing lithium from a battery material and/or an exemplary process for recycling lithium ion battery materials.

### DEFINITIONS

As used herein, “a” or “an” entity refers to one or more of that entity, e.g., “a compound” refers to one or more compounds or at least one compound unless stated otherwise. As such, the terms “a” (or “an”), “one or more”, and “at least one” are used interchangeably herein.

As used herein, the term “material” refers to the elements, constituents, and/or substances of which something is composed or can be made.

As used herein, the term “chlor-alkali-electrolysis” refers to a process for producing chlorine gas from a liquid or solution comprising chloride ions by electrolysis.

As used herein, the term “electrolysis” refers to the chemical decomposition produced by passing an electric current through a liquid or solution comprising ions.

As used herein, the term “chlorinated lime” refers to a mixture of calcium chloride, calcium hydroxide, and calcium hypochlorite.

### Black Mass:

“Black mass” refers to materials comprising lithium derived from, for example, a lithium ion battery, lithium ion battery waste, lithium ion battery production scrap, lithium ion cell production scrap, lithium ion cathode active material, and/or combinations thereof by mechanical processes such as mechanical comminution. For example, black mass may be derived from battery scrap by mechanically treating the battery scrap to obtain the active components of the electrodes such as graphite and cathode active material and may include impurities from the casing, electrode foils, cables, separator, and electrolyte. In some examples, the battery scrap may be subjected to a heat treatment to pyrolyze organic (e.g. electrolyte) and polymeric (e.g. separator and binder) materials. Such a heat treatment may be performed before or after mechanical comminution of the battery material.

Lithium ion batteries may be disassembled, punched, milled, for example in a hammer mill, and/or shredded, for example in an industrial shredder. From this kind of mechanical processing the active material of the battery electrodes may be obtained. A light fraction such as housing parts made from organic plastics and aluminum foil or copper foil may be removed, for example, in a forced stream of gas, air separation or classification.

Battery scraps may stem from, e.g., used batteries or from production waste such as off-spec material. In some embodiments a battery material is obtained from mechanically treated battery scraps, for example from battery scraps treated in a hammer mill or in an industrial shredder. Such material may have an average particle diameter (D50) ranging from 1 μm to 1 cm, such as from 1 to 500 μm, and further for example, from 3 to 250 μm.

Larger parts of the battery scrap like the housings, the wiring and the electrode carrier films may be separated mechanically such that the corresponding materials may be excluded from the battery material that is employed in the process.

Mechanically treated battery scrap may be subjected to a solvent treatment in order to dissolve and separate polymeric binders used to bind the transition metal oxides to current collector films, or, e.g., to bind graphite to current collector films. Suitable solvents are N-methylpyrrolidone, N,N-dimethyl-formamide, N,N-dimethylacetamide, N-ethylpyrrolidone, and dimethylsulfoxide, in pure form, as mixtures of at least two of the foregoing, or as a mixture with 1% to 99% by weight of water.

Mechanically treated battery scrap may be subjected to a heat treatment in a wide range of temperatures under different atmospheres. The temperature range is usually in the range of 100° C. to 900° C. Lower temperatures below 300° C. may serve to evaporate residual solvents from the battery electrolyte, at higher temperatures the binder polymers may decompose while at temperatures above 400° C. the composition of the inorganic materials may change as some transition metal oxides may become reduced either by the carbon contained in the scarp material or by introducing reductive gases. In some embodiments, a reduction of lithium metal oxides may be avoided by keeping the temperature below 400° C. and/or by removing carbonaceous materials before the heat treatment.

In some embodiments, the battery material comprises at least one chosen from lithiated nickel cobalt manganese oxide, lithiated nickel cobalt aluminum oxide, lithium metal phosphate, lithium ion battery scrap, black mass derived from a lithium ion battery, and combinations there.

In some embodiments, the battery material comprises lithium metal phosphate of formula LiₓMPO₄, wherein x is an integer greater than or equal to one, and M is chosen from metals, transition metals, rare earth metals, and combinations thereof.

In some embodiments, the battery material comprises lithiated nickel cobalt manganese oxide of formula Li₁₊ₓ(NiₐCo_{b}Mn_{c}M¹_{d})₁₋ₓO₂, wherein M¹ is chosen from Mg, Ca, Ba, Al, Ti, Zr, Zn, Mo, V and Fe, zero≤x≤0.2, 0.1≤a≤0.95, zero≤b≤0.9 (such as 0.05<b≤0.5), zero≤c≤0.6, zero≤d≤0.1, and a+b+c+d=1. Exemplary lithiated nickel cobalt manganese oxides include Li₍₁₊ₓ₎[Ni_{0.33}Co_{0.33}Mn_{0.33}]₍₁₋ₓ₎O₂, Li(1+x)[Ni_{0.5}Co_{0.2}Mn_{0.3}]₍₁₋ₓ₎O₂, Li₍₁₊ₓ₎[Ni_{0.6}Co_{0.2}Mn_{0.2}]₍₁₋ₓ₎O₂, Li₍₁₊ₓ₎[Ni_{0.7}Co_{0.2}Mn_{0.3}]₍₁₋ₓ₎O₂, Li₍₁₊ₓ₎[Ni_{0.8}Co_{0.1}Mn_{0.1}]₍₁₋ₓ₎O₂ each with x as defined above, and Li[Ni_{0.85}Co_{0.13}Al_{0.02}]O₂.

In some embodiments, the battery material comprises lithiated nickel-cobalt aluminum oxides of formula Li[NiₕCOᵢAlⱼ]O₂₊ᵣ, wherein h ranges from 0.8 to 0.90, i ranges from 0.1 to 0.3, j ranges from 0.01 to 0.10, and r ranges from zero to 0.4.

In some embodiments, the battery material comprises nickel, cobalt, manganese, copper, aluminum, iron, phosphorus, or combinations thereof.

In some embodiments, wherein the battery material has a weight ratio ranging from 0.01 to 10 of lithium to a total weight of nickel, cobalt, manganese, copper, aluminum, iron, and phosphorus. In some embodiments, wherein the battery material has a weight ratio ranging from 0.01 to 5 of lithium to a total weight of nickel, cobalt, manganese, copper, aluminum, iron, and phosphorus. In some embodiments, wherein the battery material has a weight ratio ranging from 0.01 to 2 of lithium to a total weight of nickel, cobalt, manganese, copper, aluminum, iron, and phosphorus. In some embodiments, wherein the battery material has a weight ratio ranging from 0.01 to 1 of lithium to a total weight of nickel, cobalt, manganese, copper, aluminum, iron, and phosphorus.

In some embodiments, the battery material comprises LiₓMO₂ wherein x is an integer greater than or equal to one, and M is chosen from metals, transition metals, rare earth metals, and combinations thereof.

In some embodiments, a process for recycling lithium ion battery materials comprises mechanically comminuting at least one chosen from a lithium ion battery, lithium ion battery waste, lithium ion battery production scrap, lithium ion cell production scrap, lithium ion cathode active material, and combinations thereof to obtain a black mass.

### Leaching:

In some embodiments, a process for removing lithium from a battery material comprises contacting the battery material with an aqueous medium comprising at least one salt chosen from calcium hypochlorite, lithium hypochlorite, and combinations thereof to form a mixture. In some embodiments, a process for recycling lithium ion battery materials comprises mechanically comminuting at least one chosen from a lithium ion battery, lithium ion battery waste, lithium ion battery production scrap, lithium ion cell production scrap, lithium ion cathode active material, and combinations thereof to obtain a black mass, contacting the black mass with an aqueous medium comprising at least one salt chosen from calcium hypochlorite, lithium hypochlorite, and combinations thereof.

Without wishing to be bound by theory, calcium hypochlorite may oxidize an exemplary lithium metal oxide such as LiMO₂ to liberate the lithium as lithium chloride: 4LiMO₂+Ca(ClO)₂+H₂O→2LiCl+4MO₂+Ca(OH)₂+2LiOH. Using chlorinated lime of formula 3CaCl(OCl)·Ca(OH)₂·5 H₂O, and noting a possible equilibrium of 2LiOH+CaCl₂⇄2LiCl+Ca(OH), the reaction of chlorinated lime with a lithium metal oxide may be described by the equation: 6LiMO₂+[3CaCl(OCl)·Ca(OH)₂·5H₂O]→6LiCl+6MO₂+4Ca(OH)₂+2H₂O.

Alternatively, use of sodium hypochlorite may proceed according to: 2LiMO₂+NaClO+H₂O→LiCl+LiOH+MO₂+NaOH. Since sodium hydroxide may eventually increase the pH such that the oxidation potential of the hypochlorite is reduced too much to keep the reaction going, an acid may be required to lower the pH.

Use of lithium hypochlorite may proceed according to: 2LiMO₂+LiClO+H₂O→LiCl+2LiOH+MO₂. Since lithium hydroxide may eventually increase the pH such that the oxidation potential of the hypochlorite is reduced too much to keep the reaction going, an acid may be added to lower the pH.

By contrast, the pH-value may be quasi buffered when using calcium hypochlorite by the low solubility of calcium hydroxide. As such, when reacting chlorinated lime with a material comprising lithium, the lithium may be recovered as lithium chloride while a considerable amount of the calcium may be present as low soluble calcium hydroxide.

In some embodiments, the contacting step is at a temperature ranging from 20° C. to 100° C. for a duration ranging from 10 minutes to 10 hours. In some embodiments, the contacting step is at 100° C. for a duration ranging from 3 hours to 5 hours. In some embodiments, the contacting step is at 60° C. for a duration ranging from 3 hours to 5 hours. In some embodiments, the contacting step is at 25° C. for a duration ranging from 3 hours to 5 hours.

### Solid/Liquid Separation:

In some embodiments, a process for removing lithium from a battery material comprises contacting the battery material with an aqueous medium comprising at least one salt chosen from calcium hypochlorite, lithium hypochlorite, and combinations thereof to form a mixture, and separating in the mixture solids from liquids to obtain an aqueous solution comprising lithium ions. In some embodiments, a process for recycling lithium ion battery materials comprises mechanically comminuting at least one chosen from a lithium ion battery, lithium ion battery waste, lithium ion battery production scrap, lithium ion cell production scrap, lithium ion cathode active material, and combinations thereof to obtain a black mass, contacting the black mass with an aqueous medium comprising at least one salt chosen from calcium hypochlorite, lithium hypochlorite, and combinations thereof, and separating solids from liquids to obtain an aqueous solution comprising lithium ions.

A reaction slurry containing insoluble residues from the black mass such as carbon, e.g., graphite, and solid calcium hydroxide obtained from the leaching step may be separated into a liquid solution and a solid residue by solid liquid separation. In some embodiments the lithium depleted solid residue may be collected. In some embodiments, calcium hydroxide is used to produce chlorinated lime.

In some embodiments, the separating step comprises at least one process chosen from filtration, decantation, centrifugation, flocculation, sedimentation and combinations thereof to separate the solids from the liquids.

### Li/Ca Separation:

In some embodiments, a process for removing lithium from a battery material further comprises purifying the aqueous solution comprising lithium ions by at least one process chosen from adsorption, ion exchange, precipitation, crystallization, nanofiltration, concentration by water removal, drowning-out crystallization, re-dissolution of a lithium salt in an organic solvent, and combinations thereof. In some embodiments, a process for recycling lithium ion battery materials further comprises purifying the aqueous solution comprising lithium ions by at least one process chosen from adsorption, ion exchange, precipitation, crystallization, nanofiltration, concentration by water removal, drowning-out crystallization, re-dissolution of a lithium salt in an organic solvent, and combinations thereof.

A filtrate comprising lithium chloride, dissolved calcium hydroxide and some impurities e.g., aluminates, phosphates, fluorides, silicates etc. may be concentrated by evaporating water which may precipitate low soluble calcium salts like calcium aluminate, calcium fluoride, calcium silicate.

A lithium chloride solution may be further purified by, e.g., precipitation, ion exchange, adsorption reaction, nanofiltration, by crystallizing lithium chloride, and/or solvent exchange of solvent using one or more solvents selective for dissolving lithium chloride. Such solvents may be alcohols, for example, methanol and ethanol. A lithium chloride solution may be purified by drowning-out crystallization by adding a less polar solvent to the aqueous solution such as ethanol, propanol, and/or isopropanol. Drowning-out crystallization processes are described in, e.g., Taboada, Maria Elisa, et al. “Process design for drowning-out crystallization of lithium hydroxide monohydrate.” Chemical engineering research and design 85.9 (2007): 1325-1330.

A lithium/calcium separation may comprise nanofiltration, calcium precipitation as an oxalate, fluoride, phosphate, carbonate, and/or hydroxide, crystallization in water and/or methanol, solvent exchange, and/or ion exchange.

In some embodiments, calcium hydroxide is used to produce chlorinated lime.

### Li/Na Separation:

In some embodiments, a process for removing lithium from a battery material further comprises separating lithium ions from sodium ions. In some embodiments, a process for recycling lithium ion battery materials further comprises separating lithium ions from sodium ions.

A process for separating lithium ions from calcium ions may also serve as a process for separating lithium ions from sodium ions. Similarly, a process for separating lithium ions from sodium ions may also serve as a process for separating lithium ions from calcium ions.

In some embodiments, a process for separating lithium ions from sodium ions is at least one chosen from lithium precipitation e.g. as carbonate, lithium solvent extraction, lithium adsorption, lithium ion exchange and combinations thereof.

### Li Salt Transformation to LiOH:

In some embodiments, lithium salts may be transformed into the hydroxide form (LiOH). For example, Li₂CO₃ may be transformed to LiOH by reaction with Ca(OH)₂.

In some embodiments, a process for removing lithium from a battery material further comprises subjecting the aqueous solution comprising lithium ions to at least one chosen from reaction with hydroxide, LiCl electrolysis, electrodialysis, and combinations thereof. In some embodiments, a process for recycling lithium ion battery materials further comprises subjecting the aqueous solution comprising lithium ions to at least one chosen from treatment with hydroxide, LiCl electrolysis, electrodialysis, and combinations thereof.

In some embodiments, a process for removing lithium from a battery material further comprises subjecting the aqueous solution comprising lithium ions to a chlor-alkali-electrolysis process to obtain lithium hydroxide and chlorine gas. In some embodiments a process for recycling lithium ion battery materials further comprises subjecting the aqueous solution comprising lithium ions to a chlor-alkali-electrolysis process to obtain lithium hydroxide and chlorine gas.

A lithium chloride solution may be subjected to chlor-alkali-electrolysis to obtain lithium hydroxide and chlorine gas. Some electrolysis processes are described, e.g., in RU2713360 and EP3589762. Resulting lithium hydroxide may be recovered and, if necessary, further purified. Chlorine gas can be collected, and, in a preferred embodiment, the chlorine gas is used to produce chlorinated lime. In another preferred embodiment recovered calcium hydroxide is used in the production of chlorinated lime. The calcium hydroxide may be separated from a solid residue by techniques such as graphite flotation, carrier flotation, and/or carrier magnetic separation.

### LiOH·H₂O Crystallization:

In some embodiments, lithium hydroxide may be further purified by crystallization.

### Exemplary Process:

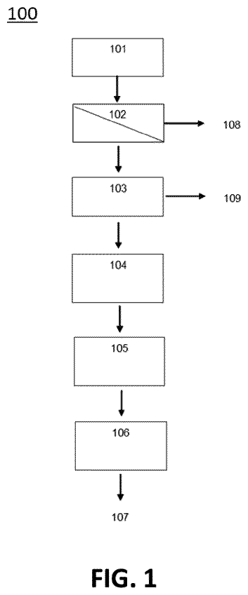

FIG. 1 depicts an exemplary process for removing lithium from a battery material and/or an exemplary processes for recycling lithium ion battery materials (100). The material may be treated in an aqueous medium with calcium hypochlorite (101). Subsequent solid-liquid separation such as filtration, decantation, centrifugation, and/or sedimentation flocculation may be performed (102). A lithium depleted solid residue may be collected (108) and may comprise calcium salts such as calcium hydroxide. The liquid portion comprising lithium may be subjected to a Li/Ca separation (103) and a calcium salt may be collected (109). For example, lithium species and calcium species may be separated using, e.g. nanofiltration, calcium precipitation, crystallization in water and/or methanol, solvent exchange, and/or ion-exchange. Calcium species may be precipitated as an oxalate, fluoride, phosphate, carbonate, and/or hydroxide. Calcium species may be precipitated as a hydroxide by treatment with, e.g., LiOH, NaOH, and/or KOH. A lithium salt solution may be further subjected to a Li/Na separation (104) such as lithium precipitation e.g., as carbonate, solvent extraction, lithium absorption lithium ion exchange. The lithium salt may be transformed to LiOH (105) by, for example, reaction with Ca(OH)₂, LiCl electrolysis, and/or electrodialysis. Optionally, Cl₂ from LiCl electrolysis may be recycled to produce calcium hypochlorite. Lithium hydroxide may subsequently be crystalized (106) to give a lithium salt such as LiOH·H₂O (107).

### EMBODIMENTS

Without limitation, some embodiments of the disclosure include:

1. A process for removing lithium from a battery material comprising contacting the battery material with an aqueous medium comprising at least one salt chosen from calcium hypochlorite, lithium hypochlorite, and combinations thereof to form a mixture, and separating in the mixture solids from liquids to obtain an aqueous solution comprising lithium ions.

2. The process according to embodiment 1, wherein the battery material comprises at least one chosen from lithiated nickel cobalt manganese oxide, lithiated nickel cobalt aluminum oxide, lithium metal phosphate, lithium ion battery scrap, and black mass derived from a lithium ion battery.

3. The process according to embodiment 1 or 2, wherein the battery material comprises lithium metal phosphate of formula LiₓMPO₄ wherein x is an integer greater than or equal to one, and M is chosen from metals, transition metals, rare earth metals, and combinations thereof.

4. The process according to any one of embodiments 1 to 3, wherein the battery material comprises lithiated nickel cobalt manganese oxide of formula Li₁₊ₓ(NiₐCo_{b}Mn_{c}M¹_{d})₁₋ₓO₂, wherein M¹ is chosen from Mg, Ca, Ba, Al, Ti, Zr, Zn, Mo, V and Fe, zero≤x≤0.2, 0.1≤a≤0.95, zero≤b≤0.9 (such as 0.05≤b≤0.5), zero≤c≤0.6, zero≤d≤0.1, and a+b+c+d=1.

5. The process according to any one of embodiments 1 to 4, wherein the battery material comprises lithiated nickel-cobalt aluminum oxides of formula Li[NiₕCOᵢAlⱼ]O₂₊ᵣ, wherein h ranges from 0.8 to 0.90, i ranges from 0.1 to 0.3, j ranges from 0.01 to 0.10, and r ranges from zero to 0.4.

6. The process according to any one of embodiments 1 to 5, wherein the battery material comprises nickel, cobalt, manganese, copper, aluminum, iron, phosphorus, or combinations thereof.

7. The process according to any one of embodiments 1 to 6, wherein the battery material has a weight ratio ranging from 0.01 to 10, from 0.01 to 5, from 0.01 to 2, or from 0.01 to 1 of lithium to a total weight of nickel, cobalt, manganese, copper, aluminum, iron, and phosphorus.

8. The process according to any one of embodiments 1 to 7, wherein at the contacting step, a weight ratio of the at least one salt chosen from calcium hypochlorite, lithium hypochlorite, and combinations thereof to a total weight of the battery material ranges from 0.1 to 100, from 0.1 to 70, from 0.1 to 50, from 0.1 to 30, from 1 to 100, from 10 to 100, from 30 to 100, or from 50 to 100.

9. The process according to any one of embodiments 1 to 8, wherein the contacting step is at a temperature ranging from 20° C. to 100° C. for a duration ranging from 10 minutes to 10 hours.

10. The process according to any one of embodiments 1 to 9, wherein the separating step comprises at least one process chosen from filtration, decantation, centrifugation, sedimentation and combinations thereof to separate the solids from the liquids.

11. The process according to any one of embodiments 1 to 10, further comprising purifying the aqueous solution comprising lithium ions by at least one process chosen from adsorption, ion exchange, precipitation, crystallization, nanofiltration, concentration by water removal, drowning-out crystallization, re-dissolution of a lithium salt in an organic solvent, and combinations thereof.

12. The process according to any one of embodiments 1 to 11, further comprising subjecting the aqueous solution comprising lithium ions to a chlor-alkali-electrolysis process to obtain lithium hydroxide and chlorine gas.

13. The process according to embodiment 12, wherein the chlorine gas is used to produce chlorinated lime and/or lithium hypochlorite.

14. The process according to any one of embodiments 1 to 13, wherein calcium hydroxide is recovered from the solids.

15. The process according to embodiments 14, wherein the calcium hydroxide is used to produce chlorinated lime.

16. A process for recycling lithium ion battery materials comprising mechanically comminuting at least one chosen from a lithium ion battery, lithium ion battery waste, lithium ion battery production scrap, lithium ion cell production scrap, lithium ion cathode active material, and combinations thereof to obtain a black mass, contacting the black mass with an aqueous medium comprising the at least one salt chosen from calcium hypochlorite, lithium hypochlorite, and combinations thereof, and separating solids from liquids to obtain an aqueous solution comprising lithium ions.

17. The process according to any one of embodiments 1 to 16, wherein the at least one salt is calcium hypochlorite.

18. The process according to embodiment 13, wherein the chlorinated lime and/or lithium hypochlorite produced from the chlorine gas obtained from the chlor-alkali-electrolysis is used for removing lithium from a battery material according to any one of embodiments 1 to 17.

19. The process according to any one of embodiments 1 to 18, wherein an initial pH at the contacting step of the mixture is less than 11, less than 10.9, less than 10.8, less than 10.7, or less than 10.6.

20. The process according to any one of embodiments 1 to 19, wherein a final pH at the contacting step of the mixture is less than 10, less than 9, or less than 8.

21. The process according to any one of embodiments 1 to 20, wherein a pH during the contacting step of the mixture ranges from 5 to less than 11, less than 10.9, less than 10.8, less than 10.7, or less than 10.6.

22. The process according to any one of embodiments 1 to 21, wherein the battery material and/or the black mass comprises less than 5 weight %, 1 weight %, or 0.1 weight % lithium carbonate, Li₂CO₃, by total weight of the battery material and/or the black mass.

23. The process according to any one of embodiments 1 to 22, wherein the battery material and/or the black mass comprises less than 5 weight %, 1 weight %, or 0.1 weight % lithium iron phosphate and iron phosphate by total weight of the battery material and/or the black mass.

Claims or descriptions that include “or” or “and/or” between at least one members of a group are considered satisfied if one, more than one, or all of the group members are present in, employed in, or otherwise relevant to a given product or process unless indicated to the contrary or otherwise evident from the context. The disclosure includes embodiments in which exactly one member of the group is present in, employed in, or otherwise relevant to a given product or process. The disclosure includes embodiments in which more than one, or all the group members are present in, employed in, or otherwise relevant to a given product or process.

Furthermore, the disclosure encompasses all variations, combinations, and permutations in which at least one limitation, element, clause, and descriptive term from at least one of the listed claims is introduced into another claim. For example, any claim that is dependent on another claim can be modified to include at least one limitation found in any other claim that is dependent on the same base claim. Where elements are presented as lists, such as, e.g., in Markush group format, each subgroup of the elements is also disclosed, and any element(s) can be removed from the group. It should be understood that, in general, where the disclosure, or aspects of the disclosure, is/are referred to as comprising particular elements and/or features, embodiments of the disclosure or aspects of the disclosure consist, or consist essentially of, such elements and/or features. For purposes of simplicity, those embodiments have not been specifically set forth in haec verba herein. Where ranges are given, endpoints are included. Furthermore, unless otherwise indicated or otherwise evident from the context and understanding of one of ordinary skill in the art, values that are expressed as ranges can assume any specific value or sub range within the stated ranges in different embodiments of the disclosure, unless the context clearly dictates otherwise.

Those of ordinary skill in the art will recognize or be able to ascertain using no more than routine experimentation, many equivalents to the specific embodiments of the disclosure described herein. Such equivalents are intended to be encompassed by the following claims.

### EXAMPLES

The following examples are intended to be illustrative and are not meant in any way to limit the scope of the disclosure.

### Abbreviations

% percent
K₂CO₃ potassium carbonate
Na₂CO₃ sodium carbonate
Na₂B₄O₇ sodium tetraborate
p.a. grade pro analysis grade
n.d. not determined
Na₂S₂O₈ sodium persulfate
w % weight percent
(NH₄)₂S₂O₈ ammonium persulfate
Ca(ClO)₂ calcium hypochlorite
NaClO sodium hypochlorite
NaOH sodium hydroxide
Li lithium
Ni nickel
Co cobalt
Mn manganese
Cu copper
Al aluminum
Fe iron
P phosphorus
F fluorine
Ca calcium

### Elemental Analysis

Elemental analysis of lithium, calcium, and manganese was determined according to the following process.

The reagents used were deionized water, hydrochloric acid (36%), K₂CO₃—Na₂CO₃ mixture (dry), Na₂B₄O₇ (dry), and hydrochloric acid 50 vol.-% (1:1 mixture of deionized water and hydrochloric acid (36%)). All reagents were p.a. grade.

Samples were prepared using 0.2-0.25 g of the black mass weighed into a Pt crucible to which was applied a K₂CO₃—Na₂CO₃/Na₂B₄O₇ fusion digestion. The sample was burned in an unshielded flame and subsequently ashed in a muffle furnace at 600° C. The remaining ash was mixed with K₂CO₃—Na₂CO₃/Na₂B₄O₇ (0.8 g/0.2 g) and melted until a clear melt was obtained. The cooled melting cake was dissolved in 30 mL of water, and 12 mL of 50 vol.-% hydrochloric acid was added. The solution was filled up to a defined volume of 100 mL. Samples were prepared in triplicate, and a blank sample was prepared for reference purposes.

Li, Ca, and Mn within the obtained sample solution was determined by optical emission spectroscopy using an inductively coupled plasma (ICP-OES). An ICP-OES Agilent 5100 SVDV was used with the following characteristics: wavelengths: Li 670.783 nm; Ca 396.847 nm; Mn 257.610 nm; internal standard: Sc 361.383 nm; dilution factors: Li 100, Ca 10, Mn 100; calibration: external.

Elemental analysis of fluorine and fluoride was performed in accordance with DIN EN 14582:2016-12 with regard to the sample preparation for the overall fluorine content determination (waste samples); the detection method was an ion selective electrode measurement. DIN 38405-D4-2:1985-07 (water samples; digestion of inorganic solids with subsequent acid-supported distillation and fluoride determination using ion selective electrode).

Other metal impurities and phosphorous were determined analogously by elemental analysis using ICP-OES (inductively coupled plasma-optical emission spectroscopy) or ICP-MS (inductively coupled plasma-mass spectrometry). Total carbon was determined with a thermal conductivity detector after combustion.

### Black Mass

Black mass was obtained by mechanical comminution of lithium ion batteries and subsequent separation of the black mass as a fine powder from the other constituents of the lithium ion batteries. The black mass had an elemental composition according to Table 1 determined by elemental analysis.

TABLE 1

| | Li | Ni | Co | Mn | Cu | Al | Fe | P | F | Ca |
|---|---|---|---|---|---|---|---|---|---|---|
| | w % | w % | w % | w % | w % | w % | w % | w % | w % | w % |
| black mass 1 | 2.5 | 12.4 | 2.9 | 3.5 | 1.2 | 1.4 | 0.08 | 0.31 | 1.9 | 0.04 |
| black mass 2 | 3.7 | 9.3 | 5.9 | 14.0 | 0.9 | 2.8 | 0.04 | 0.7 | 4.4 | 0.01 |
| black mass 3 | 2.8 | 6.9 | 4.6 | 12.2 | 0.76 | 2.1 | 0.04 | 0.61 | 4 | 0.007 |

### Example 1

The black mass (30 g) was suspended in deionized water (200 g) and to this, calcium hypochlorite containing 65% active chlorine (Merck 211389) (30 g) was added in portions under stirring. After addition, the reactor content was heated to the desired temperature. After the reaction time, the reactor content was cooled to room temperature and filtered. The filter residue was washed with deionized water to obtain a combined filtrate and a filter residue and subsequently dried in vacuo at 70° C. overnight. Both the filtrate and filter residue were analyzed by elemental analysis. From the analytical data, the recovery of the elements was calculated. The results are summarized in Table 2.

TABLE 2

| | | Weight | | | | | | | |
|---|---|---|---|---|---|---|---|---|---|
| | Black | black | Weight | Weight | Reaction | Reaction | Recovery | Content in | |
| Example | mass | mass | Ca(ClO)₂ | water | temperature | duration | in filtrate | filtrate (w %) | |
| no. | no. | g | g | g | ° C. | h | Li % | Ca % | F % |
| 2a | 1 | 30 | 30 | 275 | 100 | 4 | 95 | 0.9 | <0.1 |
| 2b | 1 | 30 | 30 | 350 | 100 | 4 | 94 | 1.2 | <0.1 |
| 2c | 1 | 30 | 30 | 200 | 60 | 4 | 77 | n.d. | n.d. |
| 2d | 1 | 30 | 30 | 275 | 60 | 4 | 88 | n.d. | n.d. |
| 2e | 1 | 30 | 30 | 350 | 60 | 4 | 84 | n.d. | n.d. |
| 2f | 1 | 30 | 30 | 275 | 25 | 4 | 54 | n.d. | n.d. |
| 2g | 1 | 30 | 30 | 350 | 25 | 4 | 52 | n.d. | n.d. |
| 2h | 2 | 30 | 30 | 200 | 100 | 4 | 73 | n.d. | n.d. |

The molar ratio Li to Cl used was 0.1 to 0.4. No base metal ions could be detected in the obtained filtrates. The pH-value was monitored during the experiment 2c. After the addition of calcium hypochlorite, the pH immediately rose from 6 to 10.5. Minutes after the addition of the hypochlorite, the pH-value was 7 and further decreased to a final value of 6.3 during the reaction. These changes in pH-value may indicate a more complex reaction scheme than the equations given in the discussion above.

### Example 2

To 1066 g of a 15 w % NaClO-solution in water, 100 g of black mass 3 was added (molar ration Li to Cl 0.4 to 2.1). The mixture was heated to 50° C. under stirring and then 83 g of 6 M hydrochloric acid was added. The pH-value dropped from 9 to 5 after which the pH-value of the solution stayed at 5. The experiment was stopped 5 h after the addition of the hydrochloric acid. The suspension was filtered, and the solid residue was washed with deionized water and dried. Elemental analysis of the filtrate and the solid residue indicated a lithium recovery of 71%. In the filtrate traces of Ni, Co, Cu and Fe were found.

### Example 3

Sodium persulfate was used instead of sodium hypochlorite in a procedure similar to that of Example 2 using the reagents and reaction conditions provided in Table 3. The molar ratio between Li and persulfate was 0.1 to 0.07. In the filtrate of the experiment without sodium hydroxide addition also 0.36% Ni and 0.03% Co was detected. In the experiment with sodium hydroxide addition no base metal ions could be detected.

TABLE 3

| | | Weight | | | | | | Li |
|---|---|---|---|---|---|---|---|---|
| | Black | black | Weight | Weight | Weight | Reaction | Reaction | recovery |
| Example | mass | mass | Na₂S₂O₈ | NaOH | water | temperature | duration | in filtrate |
| no. | no. | g | g | g | g | ° C. | h | % |
| 3a | 1 | 30 | 15.5 | 0 | 200 | 100 | 4 | 84 |
| 3b | 1 | 30 | 15.5 | 5.2 | 200 | 100 | 4 | 51 |

### Example 4

Ammonium persulfate was used instead of sodium hypochlorite in a procedure similar to that of Example 2 using the reagents and reaction conditions provided in Table 4. The molar ratio between Li and persulfate was 0.1 to 0.07. In the filtrate, 0.36% Ni and 0.03% Co was detected.

TABLE 4

| | | Weight | | | | | | |
|---|---|---|---|---|---|---|---|---|
| | Black | black | Weight | Weight | Weight | Reaction | Reaction | Li recovery |
| Example | mass | mass | (NH₄)₂S₂O₈ | NaOH | water | temperature | duration | in filtrate |
| no | no. | g | g | g | g | ° C. | h | % |
| 4a | 1 | 30 | 15.5 | 0 | 200 | 100 | 4 | 80 |

It was observed that calcium hypochlorite gives higher lithium recoveries compared to sodium hypochlorite or ammonium persulfates. In addition, the calcium hydroxide formed kept the pH-value of the reaction solution at a level high enough to avoid dissolution of base metals and low enough to keep the reaction going.

1. A process for removing lithium from a battery material comprising:
contacting the battery material with an aqueous medium comprising at least one salt chosen from calcium hypochlorite, lithium hypochlorite, and combinations thereof to form a mixture, and
separating in the mixture solids from liquids to obtain an aqueous solution comprising lithium ions.

2. The process according to claim 1, wherein the battery material comprises at least one chosen from lithiated nickel cobalt manganese oxide, lithiated nickel cobalt aluminum oxide, lithium metal phosphate, lithium ion battery scrap, and black mass derived from a lithium ion battery.

3. The process according to claim 1, wherein the battery material comprises lithium metal phosphate of formula LiₓMPO₄ wherein x is an integer greater than or equal to one, and M is chosen from metals, transition metals, rare earth metals, and combinations thereof.

4. The process according to claim 1, wherein the battery material comprises lithiated nickel cobalt manganese oxide of formula Li1+x(NiaCobMncM1d)1-xO2, wherein
M1 is chosen from Mg, Ca, Ba, Al, Ti, Zr, Zn, Mo, V and Fe,
zero≤x≤0.2,
0.1≤a≤0.95,
zero≤b≤0.9, or 0.05<b≤0.5,
zero≤c≤0.6,
zero≤d≤0.1, and
a+b+c+d=1.

5. The process according to claim 1, wherein the battery material comprises lithiated nickel-cobalt aluminum oxides of formula Li[NihCoiAlj]O2+r, wherein
h ranges from 0.8 to 0.90,
i ranges from 0.1 to 0.3,
j ranges from 0.01 to 0.10, and
r ranges from zero to 0.4.

6. The process according to claim 1, wherein the battery material comprises nickel, cobalt, manganese, copper, aluminum, iron, phosphorus, or combinations thereof.

7. The process according to claim 1, wherein the battery material has a weight ratio ranging from 0.01 to 10, 0.01 to 5, 0.01 to 2, or 0.01 to 1 of lithium to a total weight of nickel, cobalt, manganese, copper, aluminum, iron, and phosphorus.

8. The process according to claim 1, wherein at the contacting step, a weight ratio of calcium hypochlorite salt to a total weight of the battery material ranges from 0.1 to 100.

9. The process according to claim 1, wherein the contacting step is at a temperature ranging from 20° C. to 100° C. for a duration ranging from 10 minutes to 10 hours.

10. The process according to claim 1, wherein the separating step comprises at least one process chosen from filtration, decantation, centrifugation, sedimentation, flocculation, and combinations thereof to separate the solids from the liquids.

11. The process according to claim 1, further comprising purifying the aqueous solution comprising lithium ions by at least one process chosen from adsorption, ion exchange, precipitation, crystallization, nanofiltration, concentration by water removal, drowning-out crystallization, re-dissolution of a lithium salt in an organic solvent, and combinations thereof.

12. The process according to claim 1, further comprising subjecting the aqueous solution comprising lithium ions to a chlor-alkali-electrolysis process to obtain lithium hydroxide and chlorine gas.

13. The process according to claim 12, wherein the chlorine gas is used to produce chlorinated lime and/or lithium hypochlorite.

14. The process according to claim 1, wherein calcium hydroxide is recovered from the solids.

15. The process according to claim 14, wherein the calcium hydroxide is used to produce chlorinated lime.

16. A process for recycling lithium ion battery materials comprising:
mechanically comminuting at least one chosen from a lithium ion battery, lithium ion battery waste, lithium ion battery production scrap, lithium ion cell production scrap, lithium ion cathode active material, and combinations thereof to obtain a black mass,
contacting the black mass with an aqueous medium comprising at least one salt chosen from calcium hypochlorite, lithium hypochlorite, and combinations thereof, and
separating solids from liquids to obtain an aqueous solution comprising lithium ions.

17. The process according to claim 1, wherein the at least one salt is calcium hypochlorite.

18. The process according to claim 13, wherein the chlorinated lime and/or lithium hypochlorite produced from the chlorine gas obtained from the chlor-alkali-electrolysis is used for removing lithium from the battery material.

19. The process according to claim 1, wherein an initial pH at the contacting step of the mixture is less than 11.

20. The process according to claim 1, wherein a final pH at the contacting step of the mixture is less than 10.

21. The process according to claim 1, wherein a pH during the contacting step of the mixture ranges from 5 to less than 11.

22. The process according to claim 1, wherein the battery material and/or the black mass comprises less than 5 weight % lithium carbonate, Li₂CO₃, by total weight of the battery material and/or the black mass.

23. The process according to claim 1, wherein the battery material and/or the black mass comprises less than 5 weight % lithium iron phosphate and iron phosphate by total weight of the battery material and/or the black mass.
